(19) United States
(12) Patent Application Publication
(10) Pub. No.: US 2010/0271182 A1
(43) Pub. Date: Oct. 28, 2010

(54) SYSTEM FOR MONITORING DETACHABLE CONNECTIONS OF CABLE CHANNEL USING RFID TAGS

(76) Inventor: Yuliya Alekseevna Yashukova, (US)

Correspondence Address: Yuliya A. Yashukova, Sakko L Vantsetti d. 34b kv.59, Korolev, 141077, RU

(21) Appl. No.: 12/746,174

(22) PCT Filed: Dec. 3, 2008
(86) PCT No.: PCT/RU2008/000739

§ 371 Date: Jun. 4, 2010

(30) Foreign Application Priority Data
Dec. 6, 2007 (RU) 2007145103

(51) Int. Cl. G08C 17/02

(52) U.S. Cl. 340/10.1

(57) ABSTRACT

The invention relates to communication technology. Use of the invention for monitoring detachable connections of cable channel allows to identify a port or a patch cable attached to that port and does not require an RFID antenna (sensor) for each patch panel port. This technical result is achieved by steps of: providing each port of patch panel by the sensor of presence of patch cord plug; mounting an RFID tag on each patch cord plug; interrogating RFID tags by an RFID interrogator; identifying a patch panel port and a specific patch cord connected to the port correlating the time of change of the reply signal of the RFID tag and the time of change of the sensor signal.

### FIELD OF THE INVENTION

The present invention relates to the communication technology and can be used for monitoring connections of patch panels.

### BACKGROUND OF THE INVENTION

There are many different means for cable systems monitoring. The main purpose of the systems is to determine what ports of patch panels a patch cord connects to. In other words it is to monitor connection of variable part of a “cable channel” (according to ISO/IEC 11801:2002 standard).

For example, the U.S. Pat. No 6,784,802 (31 Aug 2004) discloses the similar system based on RFID. Plugs of patch cords are provided with RFID tags. Identifiers of the RFID tags are read by RFID sensors (antennas) of an RFID interrogator. The sensors are mounted at every port of a patch panel. The disadvantage of the system is that every port of the patch panel needs proper RFID sensor (antenna).

The closest analog is the system described in U.S. Pat. No 6,424,710 (23 Jul. 2002). Each port of patch panels in the system is provided with the sensor that detects the presence of a patch cord plug in the patch panel port. The disadvantage of the system is that it can not determine what specific patch cords is connected to the port of patch panel.

### SUMMARY OF THE INVENTION

Thus, the object of the present invention consists in developing such means of monitoring detachable connections of cable channel that allow to identify a patch cord and a patch panel port where a plug of the patch cord is connected to. In addition these means do not require a proper antenna of RFID interrogator for every port of the patch panel.

In order for achieving this technical result, it is proposed a system for monitoring detachable connections of cable channel using RFID tags, which system comprising: patch panels thereto each of at least some ports of the patch panels is provided with the sensor of presence, which changes its state when a patch cord plug is connected to the port; computer system, which processes the signals of said sensor of presence of plug. In addition, in accordance with the present invention, the system comprises the patch cord at least one plug of which is provided with the sensor of plug with the RFID tag which tag changes its reply signal perceived by an RFID interrogator when the plug is connected to the port of patch panel. Also the system comprises one or several RFID interrogator that is/are used to interrogate the data of said RFID tag of sensor of plug at some interval of time. The memory of the computer system contains the identifier of the RFID tag of sensor of plug and the identifier is correlated with the patch cord and/or the plug of the patch cord where the sensor of plug is mounted. The computer system is capable of identifying of the plug or/and the patch cord and the patch panel port where the plug connected to. In addition the identification is based on the signal of the sensor of presence and the data of the changing of the reply signal of the RFID tag of the sensor of the plug. And the data is/are transmitted by the RFID interrogator or interrogators to the computer system after connecting the plug provided with the sensor of plug to the port provided with the sensor of presence.

In the proposed system, the sensor of presence of plug can comprise the RFID tag which changes its reply signal perceived by the RFID interrogator when a patch cord plug is connected to the port.

The changing of reply signal of the RFID tags of sensors of plug and/or sensors of presence can be expressed itself in possibility or impossibility to identify the RFID tags by the RFID interrogator or interrogators.

In some cases changing of reply signal of the RFID tags of sensors of plug and/or sensors of presence takes place as a result of influence of the interference generated by approach the RFID tags to metal.

It is possible to provide electrical circuits of RFID tags of sensors of plug and/or sensors of presence with a switch, which can be a dry reed switch.

In other cases the changing of reply signal of the RFID tags of sensors of plug and/or sensors of presence is expressed itself in changing of data transmitted in the reply signal of the RFID tags.

The RFID interrogator can have a near-field antenna.

In addition RFID interrogator or interrogators can have an antenna multiplexer that feeds or/and receives the signal of RFID antennas depending on data of states of external sensors.

### BRIEF DESCRIPTION OF THE DRAWINGS

Throughout all drawings, the same reference numerals relate to the same or identical elements.

FIG. 1 depicts the general block diagram of the system for monitoring detachable connections of cable channel.

FIG. 2 shows an example of arrangement of plug sensors at patch cord plugs and sensors of presence at the patch panel ports according to one embodiment of the present invention.

FIG. 3 gives an example of implementation of the sensor based on RFID tag with a dry reed.

FIG. 4 shows an example of arrangement of sensors at a patch cord plug and at a patch panel port using RFID tags with dry reed switch.

### DETAILED DESCRIPTION OF THE INVENTION

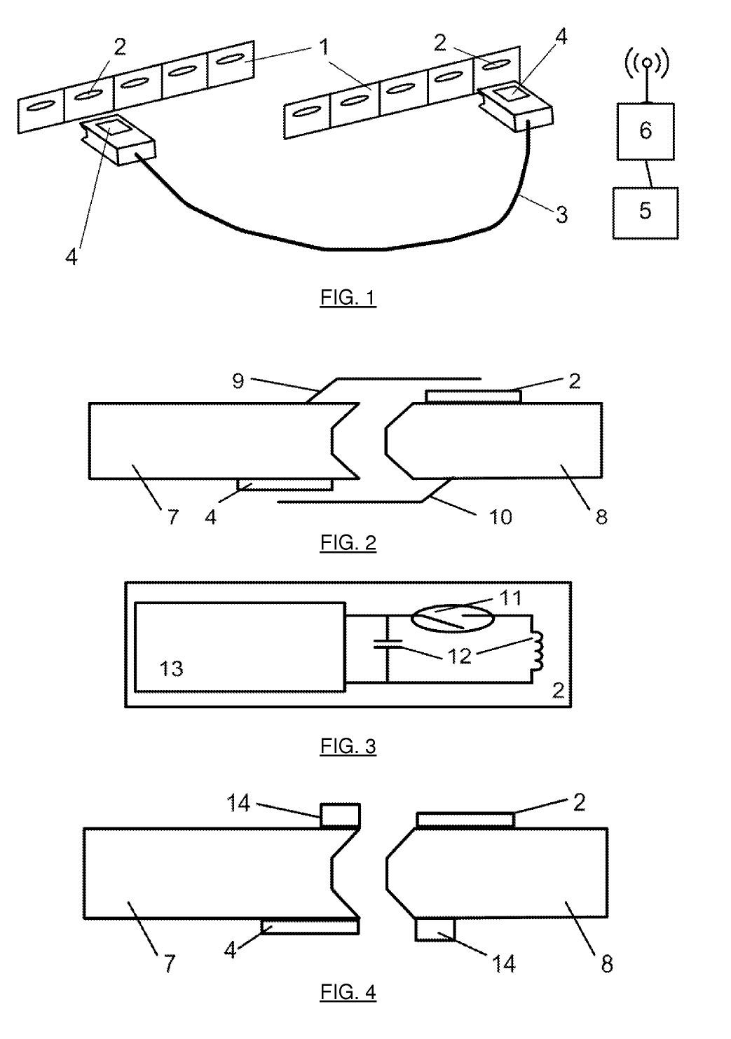

The system according to the present invention can be implemented in several similar embodiments that are, nevertheless, implemented in the same way that is presented in FIG. 1. The diagram contains patch panels 1 of 110 style (For example, 110AW2-100 produced by Commscope Inc.). Ports of the patch panels are provided with sensors of presence 2 of a patch cord plug in the patch panel port. Design of sensors 2 can match to one of designs described in U.S. Pat. No 6,424,710. That is the sensor of presence 2 can be implemented in form of a mechanical switch, dry reed switch or pair of LED-phototransistor. The FIG. 1 shows the sensors of presence 2 based on an RFID tag. The plugs of the patch cord 3 are also provided with plug sensors 4 based on a RFID tag. Identifiers of RFID tags 2 and 4 saved in the memory of a computer system 5 (hardware with a respective software). The univocal (exact) correspondence is specified between RFID tags 4 and patch cord 3 and between RFID tags 2 and ports of patch panel 1. It is not obligatory that patch cord 3 has proper identifier in the memory itself. The patch cord can be presented by pair of identifiers of its plugs. The computer system 5 is connected to a RFID interrogator 6. The RFID interrogator 6 polls from time to time RFID tags 2 and 4 and reads their identifiers. Then it sends the data to the computer system 5. At the moment of a connection the RFID tags 2 and 4 change their reply signals. For example their identifiers become inaccessible by RFID interrogator 6 or their RSSI properties are changed (Received Signal Strength Indication is described power of RFID tag reply signal and supported by Symbol XR480 RFID interrogator for example). Accordingly if identifiers are not detected they are not transmitted to the computer system 5. The computer system 5 determines missing identifiers of 2 and 4 based on previous data transmitted by RFID interrogator 6 earlier. Then the computer system 5 using the software identifies the patch cord and the patch panel port where the plug of the cord is connected. If it is used the sensor of presence in form of mechanical switch then the patch cord plug and the port are brought into correlation based on changes of signal from the tag 4 and signal from the mechanical switch that takes place almost at the similar time.

Possible design of sensors according the present invitation is presented in FIG. 2 (side view). It uses RFID tags (Alien ALN-9529) and screening strips. RFID tags 2 and 4 are mounted on a plug 7 of patch cord and 110-style connecting block of patch panel port. Screening metallic strip 9 and 10 are also mounted on the plug 7 and connecting block 8 accordingly. The strips are bent in such way that when the plug 7 is connected to connecting block 8, the strip 9 screens RFID tags 2 and the strip 10 screens RFID tags 4.

In another implementation presented in FIG. 3 a sensor of plug presence has a normal opened dry reed switch (electrical contact controlled by magnetic field). The reed switch “shorts” the antenna 12 circuit when external magnetic field appears. Also the antenna can be a quarter wave dipole (vibrator) antenna connected to a transponder chip 13 (RFID chip). The way of using such sensor is shown in FIG. 4 when the RFID tags 2 and 4 have the same design as FIG. 3 presents. At the moment of connecting the plug 7 to the connection block 8 magnets 14 close dry reed switches of RFID tags 2 and 4. The corresponding antennas is closed and they can transmit signals to the RFID interrogator.

The more complicated RFID tag can have two RFID transponder chips and two dry reed switch. The first of switches is normal closed, the second one is normal opened. In this case the RFID tag (having two chips) transmits one identifier when external magnetic field presents and another identifier when external magnetic field is absent.

The computer system 5 with software and the RFID interrogator 6 in FIG. 1 are separated units. However the logical units 5 and 6 can be implemented in one physical unit. It can be a computer with necessary (including RFID) interfaces including some interrogator antennas in some cases. The antennas can be allocated in several part of the room where the patch panel are mounted or in different telecommunication racks. The antennas can operate using magnetic part (near field) of electromagnetic field or electrical part (far field) of electromagnetic field (http://www.rfidjournal.com/glossary/Far-field%20communication). In addition RFID signal to several antennas can be feed trough multiplexer connected to sensors of opening door of telecom racks. Apparently there is no plug switching in a telecom rack when the door of a rack is closed. Thus it need not to feed a RFID signal to the respective antenna which controls the rack and to monitor states of corresponding sensors described in the present invitation. The antenna multiplexer is implemented in many RFID interrogators having several antenna input/output, for example in Alien ALR-9800. The last interrogator has also four GPIO input to connect sensors.

1. System for monitoring detachable connections of cable channel using RFID tags, which system comprising:
patch panels thereto each of at least some ports of said patch panels is provided with the sensor of presence, which changes its state when a patch cord plug is connected to the port;
computer system, which processes the signals of said sensor of presence of plug;
characterized in that
the system comprises the patch cord at least one plug of which is provided with the sensor of plug with the RFID tag which tag changes its reply signal perceived by an RFID interrogator when said plug is connected to the port of patch panel;
the system comprises one or several RFID interrogator that is/are used to interrogate the data of said RFID tag of sensor of plug at some interval of time;
the memory of said computer system contains the identifier of said RFID tag of sensor of plug which said identifier is correlated with said patch cord and/or said plug of patch cord where said sensor of plug is mounted;
said computer system is capable of identifying of said plug or/and said patch cord and said patch panel port where said plug connected to;
said identification is based on the signal of said sensor of presence and the data of said changing of the reply signal of the RFID tag of the sensor of said plug;
said data is/are transmitted by said RFID interrogator or interrogators to said computer system after connecting the plug provided with said sensor of plug to the port provided with said sensor of presence.

2. The system according to claim 1, characterized in that said sensor of presence of plug comprise the RFID tag which changes its reply signal perceived by the RFID interrogator when a patch cord plug is connected to said patch panel port.

3. The system according to claim 1 or 2, characterized in that changing of reply signal of said RFID tags of sensors of plug and/or sensor of presence is expressed itself in possibility or impossibility to identify said RFID tags by said RFID interrogator or interrogators.

4. The system according to claim 1 or 2, characterized in that changing of reply signal of said RFID tags of sensors of plug and/or sensors of presence takes place as a result of influence of the interference generated by approach said RFID tags to metal.

5. The system according to claim 1 or 2, characterized in that said RFID tags of sensors of plug and/or sensors of presence have a switch in their electrical circuit.

6. The system according to claim 5, characterized in that said switch is a dry reed switch.

7. The system according to claim 1 or 2, characterized in that said changing of reply signal of said RFID tags of sensors of plug and/or sensors of presence is expressed itself in changing of data transmitted in the reply signal of said RFID tags.

8. The system according to claim 1, characterized in that said RFID interrogator or interrogator has/have a near-field antenna.

9. The system according to claim 1, characterized in that said RFID interrogator or interrogators has/have an antenna multiplexer that feeds or/and receives the signal of antennas depending on data of states of external sensors received by said RFID interrogator or interrogators.
